(19) United States
(12) Patent Application Publication
(10) Pub. No.: US 2007/0174268 A1
(43) Pub. Date: Jul. 26, 2007

(54) Object clustering methods, ensemble clustering methods, data processing apparatus, and articles of manufacture

(75) Inventors: Christian Posse, Seattle, WA (US); Bobbie-Jo Webb-Robertson, West Richland, WA (US); Susan L. Havre, Richland, WA (US); Banu Gopalan, University Heights, OH (US); Anuj Shah, West Richland, WA (US)

Correspondence Address: WELLS ST. JOHN P.S., 601 W. FIRST AVENUE, SUITE 1300, SPOKANE, WA, 99201, US

(73) Assignee: Battelle Memorial Institute

(21) Appl. No.: 11/331,529

(22) Filed: Jan. 13, 2006

(51) Int. Cl. G06F 17/30

(52) U.S. Cl. 707/5

(57) ABSTRACT

Object clustering methods, ensemble clustering methods, data processing apparatuses, and articles of manufacture are described according to some aspects. In one aspect, an object clustering method includes accessing a plurality of respective cluster results of a plurality of different clustering solutions, wherein the cluster results of an individual one of the different clustering solutions associate a plurality of objects with a plurality of respective first clusters and indicate probabilities of the objects being correctly associated with the respective ones of the first clusters of the respective individual clustering solution, and using the cluster results including the associations of the objects and the first clusters of the respective different clustering solutions and the probabilities of the objects being correctly associated with the respective first clusters of the respective different clustering solutions, generating additional associations of the objects with a plurality of second clusters and wherein the additional associations comprise additional cluster results of an additional clustering solution.

### GOVERNMENT RIGHTS STATEMENT

This invention was made with Government support under Contract DE-AC0676RLO1830 awarded by the U.S. Department of Energy. The Government has certain rights in the invention.

### TECHNICAL FIELD

This disclosure relates to object clustering methods, ensemble clustering methods, data processing apparatuses, and articles of manufacture.

### BACKGROUND

Collection, integration and analysis of large quantities of data are routinely performed by intelligence analysts and other entities in attempts to gain insight or information into topics, subjects, or people which may be of interest. Vast numbers of different types of communications (e.g., documents, electronic mail, etc.) may be analyzed and perhaps associated with one another in an attempt to gain information or insight which is not readily comprehensible from the communications taken individually. Various analyst tools process communications in attempts to generate, identify, and investigate hypotheses.

For example, different types of clustering algorithms have been used in attempts to assist analysts with processing data. Execution of different clustering algorithms produces different and varied clustered results. In addition, results generated by fusion clustering techniques which only consider hard partitions may be optimistically biased as being accurate when inherent uncertainty exists.

At least some aspects of the disclosure provide methods and apparatus for improving analysis of quantities of data with increased accuracy and/or reduced optimistic bias.

### BRIEF DESCRIPTION OF THE DRAWINGS

Embodiments of the disclosure are described below with reference to the following accompanying drawings.

FIG. 1 is an exemplary functional block diagram of a data processing apparatus according to one embodiment.

FIG. 2 is a flow chart of an exemplary clustering method according to one embodiment.

FIG. 3 is a flow chart of an exemplary method for generating additional cluster results according to one embodiment.

FIG. 4 is a flow chart of an exemplary method for determining unknowns of a mixture model according to one embodiment.

### DETAILED DESCRIPTION

At least some aspects of the disclosure relate to methods and apparatus for clustering objects, which may also be referred to as observations. In one embodiment, a probabilistic mixture model for combining soft partitionings of one or more complementary datasets is described. Data may be partitioned in a manner that quantifies uncertainties associated with individual clusterings and fused clustering. It is believed that exemplary clustering aspects described herein provide increased robustness with respect to individual clustering methods or solutions which may cluster upon respective assumptions or biases. More specifically, it is believed that clustering or partitioning according to one embodiment based on a consensus extracted from multiple partitionings offers increased reliability. Aspects of the disclosure are directed towards ensemble clustering of objects, which may comprise a significant number of objects. Ensemble clustering may also be referred to as meta-clustering, categorical data clustering, transaction clustering, or unsupervised data fusion. Exemplary ensemble clustering embodiments may use uncertainties of previous cluster results to provide additional cluster results and/or the additional cluster results may include uncertainties.

According to an aspect of the disclosure, an object clustering method comprises accessing a plurality of respective cluster results of a plurality of different clustering solutions, wherein the cluster results of an individual one of the different clustering solutions associate a plurality of objects with a plurality of respective first clusters and indicate probabilities of the objects being correctly associated with the respective ones of the first clusters of the respective individual clustering solution, and using the cluster results including the associations of the objects and the first clusters of the respective different clustering solutions and the probabilities of the objects being correctly associated with the respective first clusters of the respective different clustering solutions, generating additional associations of the objects with a plurality of second clusters and wherein the additional associations comprise additional cluster results of an additional clustering solution.

According to another aspect of the disclosure, an object clustering method comprises accessing a plurality of respective cluster results of a plurality of different clustering solutions, wherein the cluster results of an individual one of the different clustering solutions associate a plurality of objects with a plurality of first clusters, and wherein information regarding at least one of the objects present in one of the cluster results is absent from another of the cluster results, and using the cluster results, generating additional cluster results which associate the objects with a plurality of second clusters, wherein the generating comprises estimating the information regarding the at least one of the objects which is absent from the another of the cluster results.

According to still another aspect of the disclosure, an object clustering method comprises accessing a plurality of respective cluster results of a plurality of different clustering solutions, wherein the cluster results individually associate a plurality of objects with a plurality of first clusters, using processing circuitry, processing the cluster results of the different clustering solutions, using, processing circuitry, generating additional cluster results according to the processing, and using processing circuitry, identifying a number of second clusters of the additional cluster results:

According to yet another aspect of the disclosure, an ensemble clustering method comprises accessing a mixture model, for a plurality of different number of clusters in respective cluster results, calculating parameters of the mixture model, selecting one of the cluster results, and selecting the number of clusters and the parameters which correspond to the selected one of the cluster results, wherein the parameters comprise associations of objects in clusters and probabilities of the objects being correctly associated with the clusters.

According to still yet another aspect of the disclosure, a data processing apparatus comprises processing circuitry configured to access initial cluster results indicative of clustering of a plurality of objects into a plurality of first clusters using a plurality of initial cluster solutions, wherein the first clusters of an individual one of the initial cluster results individually comprises a plurality of objects and probabilities of the respective objects of the individual respective first cluster being correctly defined within the individual respective first cluster, and wherein the processing circuitry is configured to process the probabilities of the objects being correctly defined within the respective ones of the first clusters and to provide additional cluster results including a plurality of second clusters individually comprising a plurality of the objects responsive to the processing of the probabilities.

According to an additional aspect of the disclosure, an article of manufacture comprises media comprising programming configured to cause processing circuitry to perform processing comprising accessing a plurality of initial cluster results of a plurality of different clustering solutions, wherein the results of an individual one of the different clustering solutions associate a plurality of objects with a plurality of first clusters and indicate probabilities of the objects being correctly associated with the respective ones of the first clusters of the respective individual clustering solution, and using the initial cluster results including the associations of the objects and the first clusters of the respective different clustering solutions and the probabilities of the objects being correctly associated with the respective first clusters of the respective individual clustering solutions, generating additional cluster results comprising additional associations of the objects with a plurality of second clusters of an additional clustering solution.

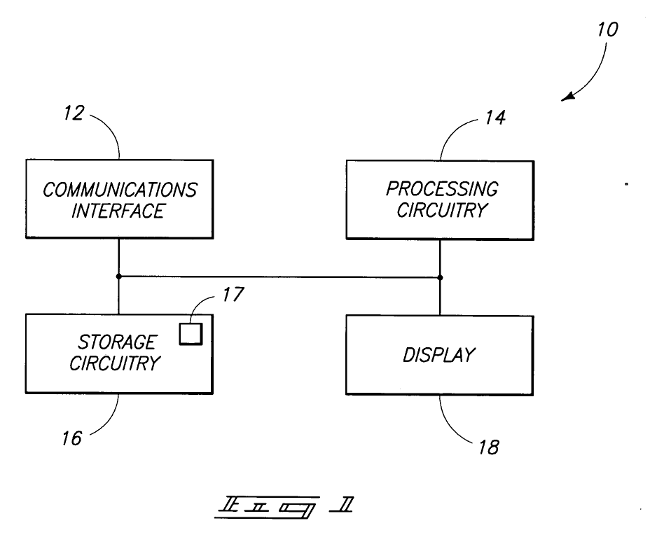

Referring to FIG. 1, an exemplary data processing apparatus 10 is illustrated according to one embodiment. The illustrated exemplary data processing apparatus 10 includes a communications interface 12, processing circuitry 14, storage circuitry 16, and a display 18. Other configurations of data processing apparatus 10 are possible in other embodiments including more, less or alternative components.

Communications interface 12 is arranged to implement communications of data processing apparatus 10 with respect to external devices (not shown). For example, communications interface 12 may be arranged to communicate information bi-directionally with respect to data processing apparatus 10. Communications interface 12 may be implemented as a network interface card (NIC), serial or parallel connection, USB port, Firewire interface, flash memory interface, floppy disk drive, or any other suitable arrangement for communicating with respect to data processing apparatus 10.

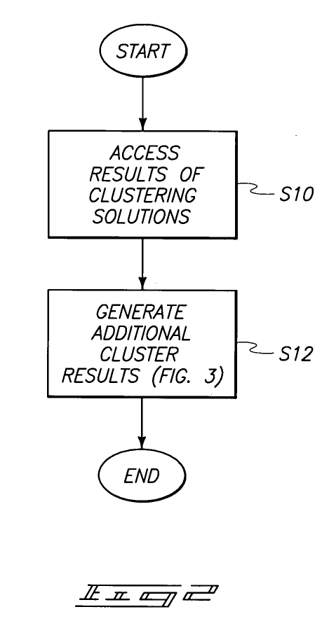

Communications interface 12 may communicate cluster data in illustrative examples. Exemplary cluster data may be generated responsive to processing operations using one or more clustering solutions or methods and may include cluster results which may comprise a plurality of different associations or “clusters” of objects which may be considered to be related or associated with one another. Cluster data may be generated externally of apparatus 10 and received within apparatus 10 via communications interface 12. In addition, cluster data may be generated by apparatus 10, for example, using an exemplary clustering method described in further detail below with respect to FIG. 2 and/or using other clustering methods. The cluster data generated by data processing apparatus 10, for example using the below described exemplary process of FIG. 2, may be generated using cluster data generated by one or more other clustering methods using apparatus 10 or devices external of apparatus 10.

In one embodiment, processing circuitry 14 is arranged to process data, control data access and storage, issue commands, and control other desired operations of apparatus 10. Processing circuitry 14 may comprise circuitry configured to implement desired programming provided by appropriate media in at least one embodiment. For example, the processing circuitry 14 may be implemented as one or more of a processor or other structure configured to execute executable instructions including, for example, software or firmware instructions, or hardware circuitry. Exemplary embodiments of processing circuitry include hardware logic, PGA, FPGA, ASIC, state machines, or other structures alone or in combination with a processor. These examples of processing circuitry 14 are for illustration and other configurations are possible.

The storage circuitry 16 is configured to store programming such as executable code or instructions (e.g., software or firmware), electronic data (e.g., cluster data), databases, or other digital information, and may include processor-usable media. Processor-usable media may be embodied in any computer program product or article of manufacture 17 which can contain, store, or maintain programming, data or digital information for use by or in connection with an instruction execution system including processing circuitry 14 in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, or other configurations capable of storing programming, data, or other digital information.

At least some embodiments or aspects described herein may be implemented using programming stored within appropriate storage circuitry 16 described above and/or communicated via a network or other transmission media and configured to control appropriate processing circuitry 14. For example, programming may be provided via appropriate media including, for example, embodied within articles of manufacture 17, embodied within a data signal (e.g., modulated carrier wave, data packets, digital representations, etc.) communicated via an appropriate transmission medium, such as a communication network (e.g., the Internet or a private network), wired electrical connection, optical connection or electromagnetic energy, for example, via communications interface 12, or provided using other appropriate communication structure or medium. Exemplary programming including processor-usable code may be communicated as a data signal embodied in a carrier wave in but one example.

Display 18 may be configured to depict visual images for observation by a user. An exemplary display 18 may comprise a monitor controlled by processing circuitry 14 in but one embodiment. In one embodiment, display 18 may be controlled to generate images using cluster data. For example, the displayed images may include clusters and objects associated with clusters of cluster results.

As mentioned above, at least some aspects are directed towards ensemble clustering. For example, data processing apparatus 10 may access cluster results computed upon a plurality of objects by a plurality of different clustering methods or solutions at an initial moment in time. Objects or observations may refer to different pieces of data which are to be clustered or partitioned. Exemplary objects include genes, correspondence, documents, samples, experiment results, people, or any other data which may have features or distinctive characteristics which enable the objects to be clustered with other objects. The clustering methods or solutions attempt to group objects having similar features or characteristics into clusters.

In some implementations, the cluster results of different clustering solutions typically include different associations or clustering of objects and respective uncertainties of the associations. In a more specific example, a cluster solution may provide a soft partitioning including a plurality of probabilities that a given object is associated with a plurality of different clusters although it may be more likely that a given object is associated with one of the different clusters. Hard partitioning may refer to results where individual objects are associated with a single cluster of the results and probability information regarding associations of the given object with other clusters of the results may be disregarded.

According to one embodiment, data processing apparatus 10 may further process cluster results including associations of a plurality of objects with a plurality of clusters. The cluster results may comprise soft partitioned data wherein an individual object may have respective probabilities of the respective object being associated with a plurality of clusters of cluster results of one clustering method. As described below, data processing apparatus 10 may process the associations and the probabilities of the cluster data according to an additional clustering solution to create additional cluster results which include associations of objects with a plurality of clusters. In one embodiment, the cluster results of the additional clustering solution may be soft partitioned comprising probabilities that a given object is associated with a plurality of clusters.

Referring to FIG. 2, an exemplary method of generating additional cluster results using ensemble clustering of respective cluster results of a plurality of initial clustering solutions is illustrated according to one embodiment. The exemplary method may be performed by processing circuitry 14 in one embodiment. Other methods are possible including more, less and/or alternative steps.

At a step S10, cluster data including cluster results from a plurality of initial clustering solutions may be accessed. The initial clustering solutions may generate respective cluster results using the same clustering algorithm operating upon different data regarding different objects, and/or cluster data generated by different clustering algorithms operating upon data regarding the same and/or different objects. A plurality of different initial clustering solutions which may be used include manual clustering or categorization solutions, statistical clustering solutions (e.g., K-means) or any other suitable clustering solution. The cluster results accessed at step S10 may be referred to as initial cluster results in one embodiment.

The initial cluster results of the initial clustering algorithms may include a plurality of clusters and a plurality of objects associated with respective ones of the clusters. The cluster results may include uncertainties in the form of probabilities of a given object being correctly associated with a plurality of clusters of the respective solution (e.g., cluster data for object 1 may include information such as 50% probability of object 1 being correctly associated with cluster A and 12.5% probabilities of object 1 being correctly associated with each of clusters B, C, D and E). The initial cluster results including probabilities of observed objects being associated with respective clusters are discussed in one example below (see Eqn. 3) where yᵢⱼ is a probability of an ith object belonging to a kth cluster for a given clustering solution j.

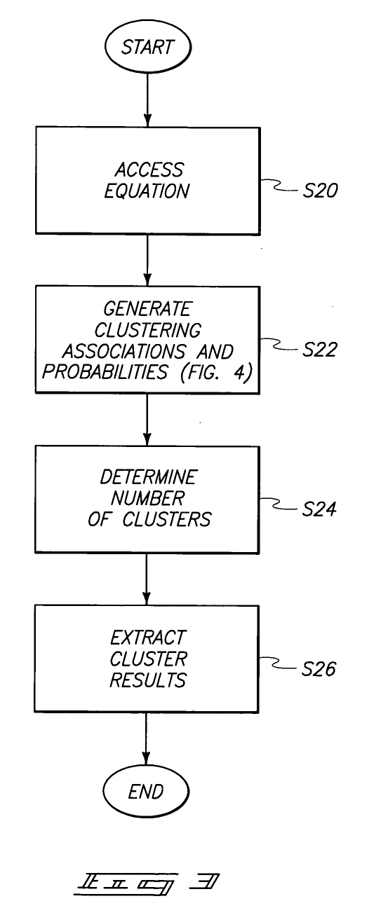

At a step S12, additional cluster results of the objects are generated using the results of the clustering solutions accessed at step S10. For example, ensemble clustering may be used to execute an additional clustering solution providing the additional cluster results. The additional cluster results may include a plurality of new clusters and new associations of objects with the new clusters in one embodiment. In addition, the additional cluster results may include probabilities of the objects being correctly associated with the indicated respective clusters. Furthermore, an individual object may be associated with a plurality of clusters and the probabilities may indicate the likelihood of the respective object being correctly associated with each of the respective clusters. Referring again to the example described below (e.g., see Eqn. 12) the additional cluster results may be described by E(zᵢₖ|Y,Θ′) corresponding to the probabilities of an ith object belonging to a kth cluster for a given number of clusters K. Additional details regarding step S12 are described below with respect to FIG. 3. The cluster results provided at step S12 may be accessed and studied by a user which may in turn lead to additional analysis and/or perhaps additional clustering.

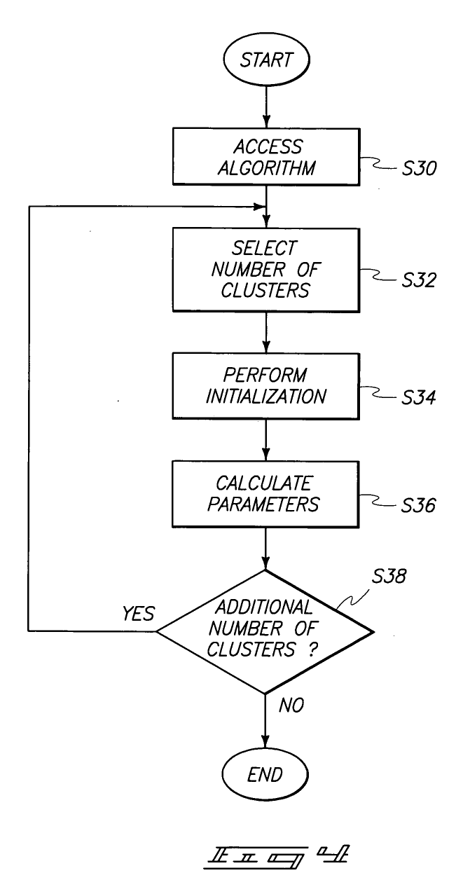

Referring to FIG. 3, an exemplary method for generating the additional cluster results using ensemble clustering of the initial cluster results is described according to one embodiment. The exemplary method may be performed by processing circuitry 14 in one embodiment. Additional details regarding one implementation of FIG. 3 are discussed below after the discussion of the flowchart of FIG. 4. Other methods are possible including more, less and/or alternative steps.

At a step S20, a mixture model equation may be accessed (e.g., an exemplary mixture model is shown below as Eqn. 1 according to one embodiment). The mixture model equation may be tailored for combining previous cluster results or partitions. The model may be simplified by adopting an assumption of class conditional independence and assigning a distribution over probabilities in one implementation. In one embodiment, a Dirichlet distribution may be used to tailor a generic mixture model for ensemble clustering. Additional details regarding one example are described below and one example of a tailored mixture model is shown as Eqn. 3. Eqn. 3 permits combination of results of different initial clustering solutions regardless of their soft or hard nature in one embodiment.

At a step S22, additional cluster results including clustering associations (e.g., objects associated with a plurality of second clusters of the additional cluster results) and probabilities of the associations are provided in one embodiment. A plurality of parameters or unknowns of the tailored mixture model may be determined to provide the clustering associations and probabilities of step S22. Additional details regarding solving for parameters are described with respect to FIG. 4. In the described embodiment, it is desired to provide different sets of additional cluster results for different numbers of clusters (e.g., provide respective sets of cluster results for different numbers of clusters (K)=1, 2, 3, 4, 5 . . . etc.) and one of the sets may be selected as the additional cluster results of the analysis as described below.

At a step S24, an optimal number of clusters of the additional cluster results of the ensemble clustering may be determined in the described embodiment. In one implementation, after the sets of additional cluster results are provided for the different number of clusters, the sets of results may be analyzed with respect to one another and a desired one of the sets of the additional cluster results may be selected which also operates to specify the number of clusters in the additional cluster results. The number of clusters may be determined according to a solution which yields robust results while utilizing reasonable computational complexities.

A Bayesian Information Criterion (BIC) may be used in one embodiment to determine the number of clusters of the additional cluster results. In one implementation, the Bayesian Information Criterion may be used to compare the results and select the number of clusters K. The selection of the number of clusters may be performed using Eqn. 22 of the below-described example in one implementation. In the described exemplary embodiment, the number of clusters of the additional cluster results may be identified automatically by the processing circuitry without user input. For example, the processing circuitry may select the desired number of clusters using the exemplary above-described processing without user input. Accordingly, the identifying the number of clusters may comprise identifying the number using the initial cluster results of the different initial clustering solutions and independent of the number of first clusters of the initial clustering solutions in one embodiment. In some executions, limitations of the number of clusters are not provided and the identified number of second clusters may be greater than an individual number of the first clusters of any individual one of the initial clustering solutions.

At a step S26, once the number of clusters in the additional cluster results is determined, the additional cluster results including the clustering associations and probabilities for the number of clusters selected in step S24 are extracted and selected (i.e., from the results of the processing for the respective selected number of clusters K) in one embodiment. The clustering associations indicate the associations of the objects with the second clusters of the additional cluster results and the probabilities are indicative of the probabilities of the objects being correctly associated with respective ones of the second clusters of the additional cluster results in the described exemplary embodiment. In one example, the probabilities may indicate the probabilities of a given object being correctly associated with each of the second clusters of the additional cluster results.

Referring to FIG. 4, an exemplary method for determining parameters or unknowns of the tailored mixture model to provide the clustering associations and probabilities of step S22 is described according to one embodiment. The exemplary method may be performed by processing circuitry 14 in one embodiment. Additional details regarding one implementation of FIG. 4 are discussed below after the discussion of the flow chart. Other methods are possible including more, less and/or alternative components.

At a step S30, an EM iterative algorithm may be accessed for use in estimating the parameters corresponding to the additional cluster results. Details of an exemplary EM algorithm are described below beginning at Eqn. 4 of one embodiment. In one implementation, a parameter in the form of hidden data represented by Z is used to facilitate solving for the parameters including the probabilities of objects belonging to clusters of the additional cluster results. Additional unknown parameters including theta and alpha may be estimated during the processing of FIG. 4 as described below.

At a step S32, the EM algorithm may be separately executed a plurality of different times for respective different numbers of clusters and the output of the different executions may be analyzed to determine the desired number of clusters for the additional cluster results of the exemplary ensemble clustering (e.g., step S24 wherein the number of clusters is selected). For example, during the first execution, the number of clusters (K) may be set to one. Thereafter, during subsequent executions of the EM algorithm, the number of clusters may be incremented for as many different executions as desired (e.g., K=1, 2, 3, 4, 5, etc.).

Referring to step S34, the EM algorithm may be used in two steps in one embodiment. Theta and alpha may be used in an E step to estimate Z and then the determined Z values may in turn be used to estimate theta and alpha during the M step. During the initial execution of the E step, it may be desired to perform an initialization wherein values of theta and alpha are estimated. In one embodiment, an initialization procedure based on Kernel Density Initialization (KDI) is used. Additional details of initialization according to one embodiment are described below with respect to Eqn. 21.

At a step S36, the parameters are determined by iterative processing using the EM algorithm and the initialized values of step S34. The determined parameters correspond to the respective number of clusters K for the given execution. As mentioned above, initialized values of theta and alpha may be used during an initial E step calculation (e.g., see Eqn. 12 in the below example). Thereafter, the determined values of Z may be used during M step calculations and the output of the M step may be reapplied to the E step and the process may be repeated in a plurality of iterations. In the below described example, the iterations may be performed until an exemplary threshold (e.g., Eqn. 18) is satisfied.

Furthermore, according to one embodiment, missing data may be accommodated by the EM algorithm (e.g., see the description of Eqns. 23-28 below). Missing data or information, such as an object present in the results of one initial clustering solution but absent from the results of another initial clustering solution, may be treated as an unknown parameter and estimated during iterative processing in one embodiment.

Additional details of determining the parameters according to one embodiment are described with respect to Eqns. 12-20 of the below-described example.

At a step S38, the value of the number of clusters K may be incremented by 1, and the process may be repeated until a desired number of executions for different values of K are performed.

The respective sets of additional cluster results may be analyzed following the estimation of the parameters for different executions of the EM algorithm corresponding to different numbers of clusters of the additional cluster results. Referring again to step S24 of FIG. 3, an optimal number of clusters of the additional cluster results may be selected by comparing the results determined at step S36 for the different values of K. As mentioned above, a Bayesian Information Criterion may be used to compare the results and select the number of clusters K in one embodiment.

As mentioned previously, a more specific example of processing of cluster data in accordance with the above exemplary methods is discussed below according to one illustrative embodiment. Other examples are possible in other embodiments.

Initially, the discussion proceeds with respect to a description of a generic mixture model where X={χ₁, . . . χ_{N}} denote a set of N objects and Π={π₁, . . . π_{J}} denote J clusterings or partitionings of objects in X Initially, it may be assumed that all objects have been processed by the clustering algorithms that generated the J partitionings (i.e., there is no missing data). According to additional aspects below, this assumption is relaxed and missing data is accommodated by the tailored mixture model and one corresponding EM algorithm in one exemplary embodiment.

Next, let Cⱼ denote the number of clusters in the j-th partitioning. For each object xᵢ and partitioning πⱼ, πⱼ(xᵢ) is such that:
πⱼ(xᵢ)={πⱼ₁(x₁), . . . π_{jC}_{ⱼ}(xᵢ)} is an array of length Cⱼ; 1.
πⱼₗ(xᵢ)≧0 and Σₗ₌₁^{C}^{ⱼ}πⱼₗ(xᵢ)=1. 2.
Hence, πⱼₗ(xᵢ) denotes the likelihood of probability of the i-th object belonging to the l-th cluster in the j-th partitioning. Given X and Π, the clustering signature associated with the i-th object xᵢ is given by the list Π(xᵢ)={π₁(χᵢ), . . . , πⱼ(xᵢ)}. The clustering signature applies to both soft and hard partitionings. If the j-th partitioning is hard, for each object xᵢ there exists a unique label k such that πⱼₗ(xᵢ)=1 and πⱼₗ(xᵢ)=0 for l′≠l. If all j-th partitionings are hard, the clustering signature can be reduced in one embodiment to a Topchy et al. signature described in Topchy, A., B., Jain, A. K., Punch, W.: A Mixture Model for Clustering Ensembles, in Proc. Of the SIAM Conference on Data Mining, 2004, pp. 379-390, the teachings of which are incorporated by reference herein, in the form of a J-dimensional array Π(xᵢ)={π₁(xᵢ), . . . , π_{J}(xᵢ)} where πⱼₗ(xᵢ) no longer represents a probability but the label of the cluster to which xᵢ belongs in the j-th partitioning.

The described exemplary approach to the ensemble clustering finds a new partition of X using the clustering signatures. A finite mixture model may be used and defined on the clustering signature space to produce a soft combined partition. The notations Y={y₁, . . . , y_{N}} where yᵢ=Π(xᵢ), y_{ij=π}ⱼ(xᵢ) and yᵢⱼₗ=πⱼₗ(xᵢ) may be used. The finite mixture model approach assumes that the quantities yᵢ are random variables drawn from a distribution described as a mixture of K densities:

$$P ( {y}_{i} \vert Θ ) = {\sum }_{k = 1}^{K} {α}_{k} {P}_{k} ( {y}_{i} \vert {θ}_{k} ) \qquad Eqn . 1$$

Each density Pₖ is associated with a cluster in the combined partition and is parameterized by θₖ. The mixing of coefficients αₖ denotes the importance of the clusters in the combined partition and are such that αₖ≧0 and Σαₖ=1. In other words, the mixture model assumes that the quantities yᵢ are dependent and may be identically generated by a two-step process in one example. First, a cluster may be chosen at random according to the probability distribution α={α₁, . . . , α_{K}}. If the k-th cluster is picked, yᵢ is then sampled from Pₖ. Finding the combined partition consists then in finding optimal estimates for the mixture model parameters Θ={α, θ₁, . . . , θ_{K}}.

Before describing how these estimates are found, a model for multivariate densities Pₖ may be defined. First, to simplify the model, a conventional assumption of class conditional independence described in Strehl, A.: Relationship-Based Clustering and Cluster Ensembles for High-dimensional Data Mining, PhD Thesis, University of Texas at Austin, 2002, the teachings of which are incorporated by reference herein, may be adopted which states that given k, the components of yᵢ are independent. Accordingly, in the described example, this means that the contributing partitionings are conditionally independent. This assumption is suitable when partitionings result from clustering algorithms applied to heterogeneous data management systems. When this assumption is less applicable, for example with partitionings resulting from applying a variety of clustering algorithms to the same object features, bias in estimating densities does not make a relevant difference in practice since the order of the density values, not their exact values, determine the combined partitioning. Moreover, though the cluster membership uncertainties in the combined solution may be less reliable, they still correctly exhibit which objects are more difficult to classify. The class conditional independence leads to the following representation:

$${P}_{k} ( {y}_{i} \vert {θ}_{k} ) = {\prod }_{j = 1}^{J} {P}_{kj} ( {y}_{ij} \vert {θ}_{kj} ) \qquad Eqn . 2$$

The next step consists of assigning a distribution over the probabilities yⱼᵢ. In the described example, a Dirichlet distribution discussed above at step S20 of FIG. 3 is used and is defined by:

$${P}_{kj} ( {y}_{ij} \vert {θ}_{kj} ) = \frac{1}{Z ( {θ}_{kj} )} {\prod }_{ℓ - 1}^{Cj} {y}_{ij ℓ}^{θ kj ℓ - 1 } \qquad Eqn . 3$$

where θₖⱼ=(θₖⱼ₁, . . . , θ_{kjCj}) is such that θₖⱼₗ>0∀l, and Z(θₖⱼ) is the normalization function Z(θₖⱼ)=Πₗ₋₁^{C}^{ⱼ}Γ(θₖⱼ₁)/Γ(Σₗ₌₁^{C}^{ⱼ}θₖⱼₗ). This distribution includes the multinomial distribution as a special case. The multinomial distribution parameterized by u=(u₁, . . . , u_{Cj}) is obtained by taking the limit (θₖⱼ₁, . . . , θ_{kjCj})→(0, . . . , 0) of Pₖⱼ(yᵢⱼ|θₖⱼ) under the constraints θₖⱼₗ/Σₗ₌₁^{C}^{ᵢ}θₖⱼₗ=uₗ for l=1, . . . , Cⱼ. Hence, the above model encompasses the multinomial product mixture model discussed in Topchy, A., B., Jain, A. K., Punch, W.: A Mixture Model for Clustering Ensembles, in Proc. Of the SIAM Conference on Data Mining, 2004, pp. 379-390, the teachings of which are incorporated by reference herein, and is commonly used in the context of hard ensemble clustering. Moreover, the model allows combination of partitionings regardless of a soft or hard nature. Eqn. 3 may comprise a tailored mixture model for use in ensemble clustering in one embodiment.

The discussion next proceeds with respect to a derivation of a combined partitioning and the utilization of the above-described EM algorithm in one illustrative embodiment. The combined partitioning derives form a maximum likelihood estimation of the mixture model parameters Θ:

$${Θ}_{MLE} = arg {max}_{Θ} L ( Θ \vert Y ) \qquad Eqn . 4$$

where L(θ|Y) denotes the loglikelihood function:

$$L ( Θ \vert Y ) = log {\prod }_{i = 1}^{N} P ( {y}_{i} \vert Θ ) \qquad Eqn . 5$$

The EM algorithm may be used to obtain Θ_{MLE}. For a combined partitioning with K clusters, EM hypothesizes the existence of hidden data Z=(z₁, . . , z_{N}) with zᵢ=(zᵢ₁, . . . , z_{iK}) such that zᵢₖ=1 if yᵢ belongs to cluster k and zᵢₖ=0 otherwise. The assumptions are that the density of an observation yᵢ given zᵢ is given by Πₖ₌₁^{K}Pₖ(yᵢ|θₖ)⁼^{ᵢₖ} and that each zᵢ is independent and identically distributed according to a multinomial distribution of one draw on K clusters with probabilities α₁, . . . α_{K}. The resulting complete-data loglikelihood is given by:

$$\begin{matrix}{L}_{c} ( Θ \vert Y , Z ) = log {\prod }_{i = 1}^{N} P ( {y}_{i} , {z}_{i} \vert Θ ) & Eqn . 6 \\ = log {\prod }_{i = 1}^{N} {\prod }_{k = 1}^{K} {( {α}_{k} {P}_{k} ( {y}_{i} \vert {θ}_{k} ) )}^{{z}_{ik}} & Eqn . 7 \\ = {\sum }_{i = 1}^{N} {\sum }_{k = 1}^{K} {z}_{ik} log {α}_{k} {P}_{k} ( {y}_{i} \vert {θ}_{k} ) & Eqn . 8\end{matrix}$$

Since Z is not observed, L_{c} cannot be utilized directly and the auxiliary function Q(Θ;Θ′) may be used where:

$$\begin{matrix}Q ( Θ ; {Θ}^{′} ) = E [ L ( Θ \vert Y , Z ) \vert Y , {Θ}^{′} ] & Eqn . 9 \\ = {\sum }_{i = 1}^{N} {\sum }_{k = 1}^{K} E ( {z}_{ik} \vert Y , {Θ}^{′} ) log {α}_{k} {P}_{k} ( {y}_{i} \vert {θ}_{k} ) & Eqn . 10\end{matrix}$$

which is the conditional expectation of the L_{c} given the observed data and the current value of the mixture model parameters. It appears that this function is a lower bound of the observed likelihood of Eqn. 5. Maximization of Q with respect to Θ is then equivalent to increasing Eqn. 5. The EM algorithm performs this optimization in an iterative manner that involves two steps in the described process.

First, given the current estimate Θ′ of the mixture model parameters, the E-step computes Q which results in evaluating the conditional expectations E(zᵢₖ|Y,Θ′) of the missing data, which are given by:

$$\begin{matrix}E ( {z}_{ik} \vert Y , {Θ}^{′} ) = \frac{{α}_{k}^{′} {P}_{k} ( {y}_{i} \vert {θ}_{k}^{′} )}{{\sum }_{k = 1}^{K} {α}_{k}^{′} {P}_{k} ( {y}_{i} \vert {θ}_{k}^{′} )} & Eqn . 11 \\ = \frac{{α}_{k}^{′} {\prod }_{j = 1}^{J} \frac{1}{Z ( {θ}_{kj}^{′} )} {\prod }_{ℓ = 1}^{{C}_{j}} {y}_{ij ℓ}^{{θ}_{kj ℓ - 1}^{′}}}{{\sum }_{k = 1}^{K} {α}_{k}^{′} {\prod }_{j = 1}^{J} \frac{1}{Z ( {θ}_{kj}^{′} )} {\prod }_{ℓ = 1}^{{C}_{j}} {y}_{ij ℓ}^{{θ}_{kj ℓ - 1}^{′}}} & Eqn . 12\end{matrix}$$

The M-step consists in maximizing Q with respect to Θ given the data and the current expected values for the missing data. Since

$$Q ( Θ ; {Θ}^{′} ) = {\sum }_{i = 1}^{N} {\sum }_{k = 1}^{K} [ \begin{matrix}E ( {z}_{ik} \vert Y , {Θ}^{′} ) log {α}_{k} + \\ E ( {z}_{ik} \vert Y , {Θ}^{′} ) log {P}_{k} ( {y}_{i} \vert {θ}_{k} )\end{matrix} ] \qquad Eqn . 13$$

Q can be maximized with respect to α and (θ₁, . . . , θ_{K}) independently. As Σₖ₌₁^{K}αₖ=1, the updated value for αₖ is obtained using a Lagrange multiplier:

$$\begin{matrix}\frac{\partial Q ( Θ ; {Θ}^{′} )}{\partial {α}_{k}} = \frac{\partial }{\partial {α}_{k}} ( \begin{matrix}{{\sum }_{i = 1}}^{N} {\sum }_{k = 1}^{K} E ( {z}_{ik} \vert Y , {Θ}^{′} ) log {α}_{k} + \\ λ ( {\sum }_{k = 1}^{K} {α}_{k} - 1 )\end{matrix} ) \\ = 0\end{matrix} \qquad Eqn . 14$$

which leads to:

$${α}_{k} = \frac{{\sum }_{i = 1}^{N} E ( {z}_{ik} \vert Y , {Θ}^{′} )}{{\sum }_{i = 1}^{N} {\sum }_{k = 1}^{K} E ( {z}_{ik} \vert Y , {Θ}^{′} )} \qquad Eqn . 15$$

A maximization with respect to (θ₁, . . . , θ_{K}) is facilitated by a class conditional independence assumption:

$$\frac{\partial Q ( Θ ; {Θ}^{′} )}{\partial {θ}_{k j ℓ}} = \frac{\partial }{\partial {θ}_{k j ℓ}} ( {\sum }_{i = 1}^{N} {\sum }_{k = 1}^{K} E ( {z}_{ik} \vert Y , {Θ}^{′} ) log {P}_{k} ( {y}_{i} \vert {θ}_{k} ) ) = 0 \qquad Eqn . 16$$

which leads to:

$$Ψ ( {θ}_{k j ℓ} ) - Ψ ( {\sum }_{ℓ = 1}^{{C}_{j}} {θ}_{k j ℓ} ) = \frac{{\sum }_{i = 1}^{N} E ( {z}_{ik} \vert Y , {Θ}^{′} ) log {y}_{i j ℓ}}{{\sum }_{i = 1}^{N} E ( {z}_{ik} \vert Y , {Θ}^{′} )} \qquad Eqn . 17$$

where Ψ is a digamma function. This system can be solved efficiently using a fixed-point method as described in Madigan, R., Raferty, A. E., Volinsky, C., Hoeting, J.: Bayesian Model Averaging, In Proc. Of the American Association for Artificial Intelligence (AAAI) Workshop on Integrating Multiple Learned Models, 1996, pp. 77-83, the teachings of which are incorporated by reference herein.

The E and M steps are repeated until a convergence criterion is satisfied. In one embodiment, the criterion may based on the increase of the likelihood value between two M steps, on the change in the mixture model parameters, or on the stability of the cluster assignments (in the context of hard ensemble clustering). In one embodiment, the stability of the probabilities of belonging to a certain cluster are of interest. These probabilities are given by conditional expectations E(zᵢₖ|Y,Θ). Therefore, a suitable convergence criterion can be based on the Euclidean distance:

$${\sum }_{i = 1}^{N} {\sum }_{k = 1}^{K} {( E ( {z}_{ik} \vert Y , Θ ) - E ( {z}_{ik} \vert Y , {Θ}^{′} ) )}^{2} < τ \qquad Eqn . 18$$

where τ is a tolerance level.

Upon convergence, a hard ensemble partitioning can be obtained using Bayes' rule, which states that the i-th object is assigned to the j-th cluster if

$$E ( {z}_{ij} \vert Y , {Θ}_{MLE} ) = {max}_{k} ( E ( {z}_{i k} \vert Y , {Θ}_{MLE} ) ) . \qquad Eqn . 19$$

Moreover, the uncertainty associated with this assignment is given by:

$$U ( i ) = 1 - {max}_{k} ( E ( {z}_{ik} \vert Y , {Θ}_{MLE} ) ) \qquad Eqn . 20$$

As mentioned above with respect to step S34 of the exemplary method of FIG. 4, an initialization procedure may be performed in view of a weakness of the EM algorithm being dependent on the initial solution. A possible starting solution lies in the attraction domain of the global optimum. However, one may want to generate a starting solution with a computational effort that is less or comparable to the EM algorithm. Referring to McLachlan, G. and Peel, D.: Finite Mixture Models, Wiley, New York, 2000, the teachings of which are incorporated by reference herein, several schemes have been investigated and a promising initialization for a hard ensemble clustering problem results from the noisy-marginal method proposed by Stehl, A., Ghosh, J.,: Cluster Ensembles—A Knowledge Reuse Framework for Combining Partitionings, Journal of Machine Learning Research, 3, 2002, pp. 583-617, the teachings of which are incorporated by reference herein. However, with real data, the noisy-marginal method was observed to not improve on the random starting solution approach. The above-mentioned KDI (Kernel Density Initialization) described in Li, T., Ma, S., Ogihara, M.: Entrophy-Based Criterion in Categorical Clustering, In Proc. Of the 2002 ACM International Conference on Machine Learning, Banff, Alberta, 2004, the teachings of which are incorporated by reference herein, provides a simple density-based procedure for approximating centroids for the initialization step of iteration-based clustering algorithms. This model-independent procedure has been observed to outperform other initialization techniques on both synthetic and real data. For that reason, an initialization procedure based on KDI is proposed in the described example.

More specifically, KDI generates K cluster centroids m=(m₁, . . . , m_{K}) in two steps. First, it constructs a coarse non-parametric density estimate of the data (Y) and the extracts K peaks of the density estimate that are well separated to provide m. Its complexity is n log n where n denotes the size of the subsample of the data used by this algorithm. More precisely, given a subsample y̅₁, . . . , y̅ₙ of Y, KDI two steps are:

Step 1
For each y̅ᵢ do

densityᵢ = 0
for σ time do

Choose at random yⱼ in Y
If dist( y̅ᵢ, yⱼ)<ε, increase densityᵢby some constant

end for

end for
Step 2
Sort y̅ᵢ by densityᵢin decreasing order →
y̅_{[l]},..., y̅_{[n]}
m←NULL
for k = 1 to K do

Add to m the first object y̅_{[ik]} from the sorted data
Remove y̅_{[ik]} from the data
Remove all y̅_{[i]} such that dist( y̅_{[ik], y[j]}) < k

end for

where dist is a suitable distance defined on the Y space. In one example, Euclidean distance may be used. The tuning parameters n, σ, ε and k allow the algorithm to be customized to maximize the trade-off between speed and precision. Since 0≦dist( . , . )≧2J, suitable values are ε=k/2, k=J/K, σ=log N, and n=N/log N and the KDI complexity reduces to the complexity of the EM algorithm.

Based on the centroids m, initial values for the condition expectations of the missing data Z may be derived by considering the distance of the data to the centroids:

$$E ( {z}_{ik} \vert Y , m ) = \frac{1 / dist ( {y}_{i} , {m}_{k} )}{{\sum }_{k = 1}^{K} 1 / dist ( {y}_{i} , {m}_{k} )} \qquad Eqn . 21$$

The above-described initialization method may be compared with the standard random starting solution procedure and the initialization by the k-means algorithm.

As mentioned above with respect to step S24 of the method of FIG. 3, a Bayesian Information Criterion may be used to determine an appropriate number of clusters. In one embodiment, a processing complexity of the model is weighed against the improvement of the results. In the described example, the BIC criterion for selecting an optimal number K of clusters in a combined partitioning is an approximation of the Bayes factor for model selection which is given by:
BIC(i K)=2L(Θ_{MLE}|Y)−n_{K}logN Eqn. 22
where n_{K} denotes the number of independent parameters to be estimated in the mixture model. The larger the BIC value, the stronger the evidence for the model. In one embodiment, the only constraint is on the mixing parameters α which leads to nₖ=(1+Σ_{J-1}^{J}Cⱼ)K−1. Accordingly, the processing circuitry 14 may determine the number of clusters automatically without a user specifying the number of clusters desired in the result which can degrade the cluster results. Also, the number of clusters of the additional clusters results resulting from the analysis may be different than the number of clusters of any of the initial clustering solutions inasmuch as the number of clusters resulting from the analysis is not limited by the number of clusters of the individual initial clustering solutions. In particular, the number of clusters of the additional cluster results may exceed the number of clusters of any individual one of the different initial clustering solutions.

As discussed above with respect to step S36 of FIG. 4, missing data may be accommodated using the EM algorithm. The missing data may be treated as unknown parameter(s) which are estimated during processing of the EM algorithm. One example may be generalized to the case of incomplete partitions, for example, objects with missing probabilities of belonging to some of the contributing partitionings. First, each object yᵢ may be split into missing and observed components yᵢ=(yᵢ^{obs}, yᵢ^{mis}). Each object can have different missing components. The function Q becomes

$$\begin{matrix}Q ( Θ ; {Θ}^{′} ) = E [ {L}_{e} ( Θ \vert {Y}^{obs} , {Y}^{mis} , Z ) \vert {Y}^{obs} , {Θ}^{′} ] = & Eqn . 23 \\ {\sum }_{i = 1}^{N} {\sum }_{k = 1}^{K} E ( {z}_{ik} \vert {Y}^{obs} , {Θ}^{′} ) ( log {α}_{k} - {\sum }_{j - 1}^{J} log Z ( {θ}_{k j} ) ) + & Eqn . 24 \\ {\sum }_{i = 1}^{N} {\sum }_{k = 1}^{K} {\sum }_{j : {y}^{obs}} {\sum }_{ℓ = 1}^{{C}_{j}} ( {θ}_{k j ℓ} - 1 ) E ( {z}_{ik} \vert {Y}^{obs} , {Θ}^{′} ) log {y}_{i j ℓ}^{obs} + & Eqn . 25 \\ {\sum }_{i = 1}^{N} {\sum }_{k = 1}^{K} {\sum }_{j : {y}^{mis}} {\sum }_{ℓ = 1}^{{C}_{j}} ( {θ}_{k j ℓ} - 1 ) E ( {z}_{ik} log {y}_{i j ℓ}^{mis} \vert {Y}^{obs} , {Θ}^{′} ) & Eqn . 26\end{matrix}$$

Thus, the E step computes the conditional expectations E(zᵢₖ|Y^{obs},Θ′) and E(zᵢₖ log yᵢⱼₗ^{mis}|Y^{obs},Θ′). The quantities E(zᵢₖ|Y^{obs},Θ′) are calculated according to Eqn. 11 with the products over all partitionings replaced by products over partitionings with known labels:

$$\begin{matrix}{\prod }_{j = 1}^{J} -> {\prod }_{j : {y}_{i}^{obs}} \\ Then , & \\ \begin{matrix}E ( {z}_{ik} log {y}_{i j ℓ}^{mis} \vert {Y}^{obs} , {Θ}^{′} ) = E ( log {y}_{ij ℓ}^{mis} \vert {z}_{ik} \\ = 1 , {Y}^{obs} , {Θ}^{′} ) E ( {z}_{ik} \vert {Y}^{obs} , {Θ}^{′} )\end{matrix} & Eqn . 27 \\ = ( Ψ ( {θ}_{kjl}^{′} ) - Ψ ( {\sum }_{ℓ - 1}^{{C}_{j}} {θ}_{k j l}^{′} ) ) E ( {z}_{ik} \vert {Y}^{obs} , {Θ}^{′} ) & Eqn . 28\end{matrix}$$

The formal expressions of Eqns. 15 and 17 for the mixture model parameters in the M step remain the same except for the replacement of E(zᵢₖ|Y,Θ′) by E(zᵢₖ|Y^{obs},Θ′) and of E(zᵢₖ|Y,Θ′)log yᵢⱼₗ by E(zᵢₖ log yᵢⱼₗ^{mis}|Y^{obs},Θ′). Finally, the initialization techniques discussed in the previous sections may be combined with an imputation method to handle missing data as discussed in Schafer, J. L.: Analysis of Incomplete Multivariate Data, Chapman & Hall, London, 1997, the teachings of which are incorporated by reference herein.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. An object clustering method comprising:
accessing a plurality of respective cluster results of a plurality of different clustering solutions, wherein the cluster results of an individual one of the different clustering solutions associate a plurality of objects with a plurality of respective first clusters and indicate probabilities of the objects being correctly associated with the respective ones of the first clusters of the respective individual clustering solution; and
using the cluster results including the associations of the objects and the first clusters of the respective different clustering solutions and the probabilities of the objects being correctly associated with the respective first clusters of the respective different clustering solutions, generating additional associations of the objects with a plurality of second clusters and wherein the additional associations comprise additional cluster results of an additional clustering solution.

2. The method of claim 1 wherein the generating further comprises providing probabilities of the objects being correctly associated with respective ones of the second clusters of the additional cluster results.

3. The method of claim 1 wherein the generating further comprises providing a probability of one of the objects being correctly associated with a plurality of the second clusters of the additional cluster results.

4. The method of claim 1 wherein the generating comprises determining a number of the second clusters of the additional clustering solution using processing circuitry.

5. The method of claim 1 wherein information regarding one of the objects present in the cluster results of one of the different clustering solutions is absent from the cluster results of another of the different clustering solutions.

6. The method of claim 1 wherein the generating comprises generating using a mixture model.

7. The method of claim 6 wherein the mixture model implements a Dirichlet distribution.

8. The method of claim 6 further comprising estimating unknowns of the mixture model using an iterative algorithm.

9. The method of claim 8 further comprising initializing the unknowns during an initial execution of the iterative algorithm.

10. An object clustering method comprising:
accessing a plurality of respective cluster results of a plurality of different clustering solutions, wherein the cluster results of an individual one of the different clustering solutions associate a plurality of objects with a plurality of first clusters, and wherein information regarding at least one of the objects present in one of the cluster results is absent from another of the cluster results; and
using the cluster results, generating additional cluster results which associate the objects with a plurality of second clusters, wherein the generating comprises estimating the information regarding the at least one of the objects which is absent from the another of the cluster results.

11. The method of claim 10 wherein the estimating comprises estimating using a plurality of iterative executions of an algorithm.

12. The method of claim 10 wherein the estimating comprises estimating using the algorithm comprising an EM algorithm.

13. The method of claim 10 further comprising classifying the information as an unknown and wherein the estimating comprises estimating the unknown.

14. The method of claim 10 wherein the information which is absent comprises probability information regarding an association of the at least one of the objects with one of the first clusters.

15. An object clustering method comprising:
accessing a plurality of respective cluster results of a plurality of different clustering solutions, wherein the cluster results individually associate a plurality of objects with a plurality of first clusters;
using processing circuitry, processing the cluster results of the different clustering solutions;
using processing circuitry, generating additional cluster results according to the processing; and
using processing circuitry, identifying a number of second clusters of the additional cluster results.

16. The method of claim 15 wherein the generating comprises associating the objects with respective ones of the second clusters of the additional cluster results.

17. The method of claim 15 wherein the identifying comprises identifying without user input.

18. The method of claim 15 wherein the identifying comprises identifying independent of the number of first clusters of the different clustering solutions.

19. The method of claim 15 wherein the identifying comprises identifying using the cluster results of the different clustering solutions.

20. The method of claim 15 wherein the identifying comprises identifying the number of second clusters greater than an individual number of the first clusters of any individual one of the different clustering solutions.

21. The method of claim 15 wherein limitations of the number of second clusters are not provided upon the identifying of the number of second clusters of the additional cluster results.

22. The method of claim 15 wherein the identifying comprises identifying automatically without user input.

23. An ensemble clustering method comprising:
accessing a mixture model;
for a plurality of different number of clusters in respective cluster results, calculating parameters of the mixture model;
selecting one of the cluster results; and
selecting the number of clusters and the parameters which correspond to the selected one of the cluster results, wherein the parameters comprise associations of objects in clusters and probabilities of the objects being correctly associated with the clusters.

24. The method of claim 23 wherein the calculating comprises calculating using an iterative algorithm.

25. The method of claim 24 wherein the calculating comprises estimating the parameters using the iterative algorithm.

26. The method of claim 24 further comprising initializing initial executions of the iterative algorithm for respective ones of the calculatings.

27. A data processing apparatus comprising:
processing circuitry configured to access initial cluster results indicative of clustering of a plurality of objects into a plurality of first clusters using a plurality of initial cluster solutions, wherein the first clusters of an individual one of the initial cluster results individually comprise a plurality of objects and probabilities of the respective objects of the individual respective first cluster being correctly defined within the individual respective first cluster; and
wherein the processing circuitry is configured to process the probabilities of the objects being correctly defined within the respective ones of the first clusters and to provide additional cluster results including a plurality of second clusters individually comprising a plurality of the objects responsive to the processing of the probabilities.

28. The apparatus of claim 27 wherein the additional cluster results indicate probabilities of the accuracies of the associations of the objects with the second clusters.

29. The apparatus of claim 27 wherein the additional cluster results indicate probabilities of one of the objects being correctly associated with a plurality of the second clusters of the additional cluster results.

30. The apparatus of claim 27 wherein the processing circuitry is configured to determine the number of the second clusters using the initial cluster results.

31. The apparatus of claim 27 wherein the processing circuitry is configured to determine the number of the second clusters using the initial cluster results and without limitations upon the number of the second clusters to be determined.

32. The apparatus of claim 27 wherein information regarding one of the objects present in one of the initial cluster results is absent from another of the initial cluster results.

33. The apparatus of claim 32 wherein the processing circuitry is configured to estimate the information absent from the another of the initial cluster results.

34. The apparatus of claim 27 wherein the processing circuitry is configured to execute a mixture model to provide the additional cluster results.

35. The apparatus of claim 34 wherein the processing circuitry is configured to execute an iterative algorithm to estimate unknowns of the mixture model.

36. The apparatus of claim 35 wherein the processing circuitry is configured to initialize unknowns during an initial execution of the iterative algorithm.

37. An article of manufacture comprising:
media comprising programming configured to cause processing circuitry to perform processing comprising:
accessing a plurality of initial cluster results of a plurality of different clustering solutions, wherein the initial cluster results of an individual one of the different clustering solutions associate a plurality of objects with a plurality of first clusters and indicate probabilities of the objects being correctly associated with the respective ones of the first clusters of the respective individual clustering solution; and
using the initial cluster results including the associations of the objects and the first clusters of the respective different clustering solutions and the probabilities of the objects being correctly associated with the respective first clusters of the respective individual clustering solutions, generating additional cluster results comprising additional associations of the objects with a plurality of second clusters of an additional clustering solution.
